(19) United States
(12) Patent Application Publication
(10) Pub. No.: US 2026/0036164 A1
(43) Pub. Date: Feb. 5, 2026

(54) THRUST BEARING AND ROTARY MACHINE

(71) Applicant: MITSUBISHI HEAVY INDUSTRIES COMPRESSOR CORPORATION, Hiroshima (JP)

(72) Inventors: Yuki Nakamura, Hiroshima-shi (JP); Yuzo Tsurusaki, Hiroshima-shi (JP); Yuichi Sasaki, Hiroshima-shi (JP)

(73) Assignee: MITSUBISHI HEAVY INDUSTRIES COMPRESSOR CORPORATION, Hiroshima (JP)

(21) Appl. No.: 19/200,800

(22) Filed: May 7, 2025

(30) Foreign Application Priority Data
Jul. 31, 2024 (JP) 2024-124236

(51) Int. Cl. F16C 33/10; F16C 17/04

(52) U.S. Cl. CPC F16C 33/1085; F16C 17/045; F16C 33/108; F16C 2360/24

(57) ABSTRACT

A thrust bearing includes a first bearing assembly arranged on a first side in an axial direction with respect to a thrust collar and a second bearing assembly arranged on a second side in the axial direction with respect to the thrust collar. The first bearing assembly includes a plurality of first pad assemblies having a first pad surface and a first carrying case in which a first insertion groove is formed, the first carrying case specifying positions of the plurality of first pad assemblies. The second bearing assembly includes a plurality of second pad assemblies having a second pad surface and a second carrying case in which a second insertion groove is formed, the second carrying case specifying positions of the plurality of second pad assemblies. The first insertion groove is formed in a shape by which each of the plurality of second pad assemblies cannot be inserted up to a first specified position, and the second insertion groove is formed in a shape by which each of the plurality of first pad assemblies cannot be inserted up to a second specified position.

### CROSS-REFERENCE TO RELATED APPLICATIONS

This application claims the benefit of priority to Japanese Patent Application Number 2024-124236 filed on Jul. 31, 2024. The entire contents of the above-identified application are hereby incorporated by reference.

### TECHNICAL FIELD

The disclosure relates to a thrust bearing and a rotary machine.

### RELATED ART

In a rotary machine having a rotor such as a steam turbine or a compressor, a bearing device is used for rotatably supporting the rotor. Examples of such a bearing device include a journal bearing that supports a load in a radial direction of the rotor and a thrust bearing that supports a load in an axial direction of the rotor.

For example, JP 2015-94373 A discloses a tilting pad thrust bearing including a plurality of pads arranged on an outer circumference of a rotor shaft so as to face a thrust collar and a plurality of oil fillers provided among the plurality of pads.

### SUMMARY

In the thrust bearing, pads are arranged sandwiching a thrust collar in the axial direction. The load in the axial direction from the rotor generated in the thrust bearing is mainly applied to the pad on one side with respect to the thrust collar in the axial direction. That is, the load applied to the pad is greatly different on one side and the other side in the axial direction with respect to the thrust collar. Thus, the pad and components of the thrust bearing such as a carrying case supporting the pad need to be different for optimizing the shape on one side and the other side in the axial direction with respect to the thrust collar. However, since the components of the thrust bearing are similar on both one side and the other side in the axial direction with respect to the thrust collar, the components may be erroneously assembled. When the rotor shaft is large in size, disassembly work and assembly work are very large in scale. Therefore, in a case where the disassembly work and the assembly work are performed again due to erroneous assembly, a large loss occurs. Therefore, a thrust bearing that can reduce erroneous assembly is required.

The disclosure has been made to solve the above problem, and an object of the disclosure is to provide a thrust bearing and a rotary machine that can reduce erroneous assembly.

In order to solve the above problem, a thrust bearing according to the disclosure is a thrust bearing that supports, through a thrust collar arranged protruding to an outer side in a radial direction from a rotor shaft that rotates about an axis, a load in an axial direction of the rotor shaft, the thrust bearing including: a first bearing assembly arranged on a first side in the axial direction with respect to the thrust collar; and a second bearing assembly arranged opposite to the first bearing assembly in the axial direction with reference to the thrust collar and on a second side in the axial direction with respect to the thrust collar, in which the first bearing assembly includes a plurality of first pad assemblies having a first pad surface opposing the thrust collar in the axial direction, arranged apart in a circumferential direction with respect to the thrust collar, and having an identical shape, and a first carrying case in which a first insertion groove that can hold, at a first specified position, a first pad assembly of the plurality of first pad assemblies inserted from the outer side in the radial direction is formed, the first carrying case specifying positions of the plurality of first pad assemblies, the second bearing assembly includes a plurality of second pad assemblies having a second pad surface opposing the thrust collar in the axial direction, arranged apart in the circumferential direction with respect to the thrust collar, and having an identical shape, and a second carrying case in which a second insertion groove that can hold, at a second specified position, a second pad assembly of the plurality of second pad assemblies inserted from the outer side in the radial direction is formed, the second carrying case specifying positions of the plurality of second pad assemblies, the first insertion groove is formed in a shape by which the second pad assembly cannot be inserted up to the first specified position, and the second insertion groove is formed in a shape by which the first pad assembly cannot be inserted up to the second specified position.

The rotary machine according to the disclosure includes the thrust bearing and a rotor shaft rotatably supported by the thrust bearing.

The thrust bearing and the rotary machine of the disclosure can reduce erroneous assembly.

### BRIEF DESCRIPTION OF DRAWINGS

The disclosure will be described with reference to the accompanying drawings, wherein like numbers reference like elements.

FIG. 1 is a view illustrating a schematic configuration of a steam turbine according to the present embodiment.

FIG. 2 is an enlarged view of a main part illustrating a thrust bearing according to the present embodiment.

FIG. 3 is a perspective view of a main part illustrating an inner side of the thrust bearing with an upper half of the bearing cover according to the present embodiment removed.

FIG. 4 is a cross-sectional view taken along line IV-IV in FIG. 2, illustrating a first bearing assembly in a state of facing a first pad surface according to the present embodiment.

FIG. 5 is a cross-sectional view taken along line V-V in FIG. 2, illustrating a second bearing assembly in a state of facing a second pad surface according to the present embodiment.

FIG. 6 is a cross-sectional view of a main part taken along line VI-VI in FIG. 2, illustrating a first pad assembly inserted into a first insertion groove of a first carrying case according to a first embodiment.

FIG. 7 is a cross-sectional view of a main part corresponding to FIG. 6, illustrating a second pad assembly inserted into the first insertion groove of the first carrying case according to the first embodiment.

FIG. 8 is a cross-sectional view of a main part corresponding to FIG. 6, illustrating the first pad assembly inserted into the first insertion groove of the first carrying case according to a second embodiment.

FIG. 9 is a cross-sectional view of a main part corresponding to FIG. 6, illustrating the second pad assembly inserted into the first insertion groove of the first carrying case according to the second embodiment.

FIG. 10 is a cross-sectional view of a main part illustrating the second pad assembly inserted into a second insertion groove of a second carrying case according to the second embodiment.

FIG. 11 is a cross-sectional view of a main part illustrating the first pad assembly inserted into the second insertion groove of the second carrying case according to the second embodiment.

FIG. 12 is a cross-sectional view illustrating a first key according to a third embodiment about to be inserted into a second key seat.

FIG. 13 is a cross-sectional view illustrating the first key according to a modification example of the third embodiment about to be inserted into the second key seat.

### DESCRIPTION OF EMBODIMENTS

Hereinafter, embodiments for carrying out a thrust bearing and a rotary machine according to the disclosure will be described with reference to the accompanying drawings. However, the disclosure is not limited only to these embodiments.

### Configuration of Rotary Machine

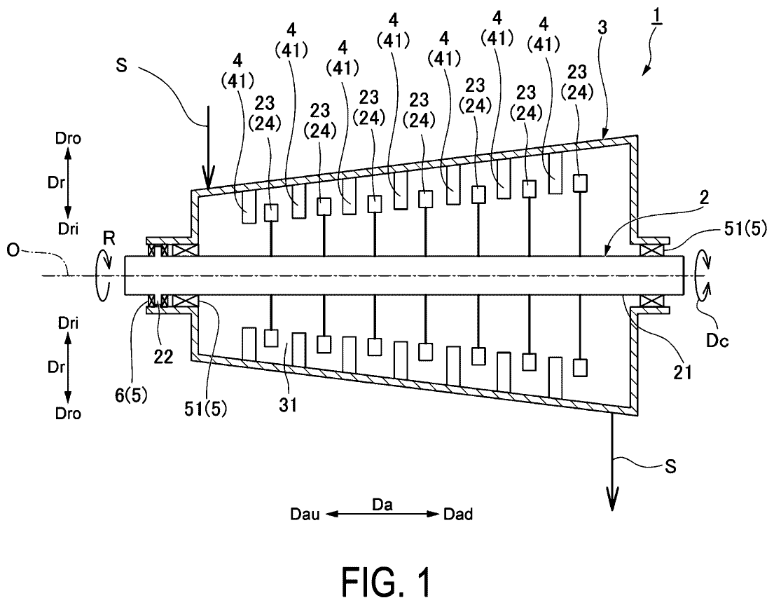

As illustrated in FIG. 1, a rotary machine is a machine in which a rotor shaft 2 is rotatably supported by a thrust bearing 6 with respect to a casing 3. Examples of the rotary machine include a compressor, a turbine, a motor, and a pump. In the present embodiment, as an example, a steam turbine 1 among the turbines will be described as a rotary machine. As illustrated in FIG. 1, the steam turbine 1 of the present embodiment mainly includes the rotor shaft 2, the casing 3, a plurality of stator vane rows 4, and a bearing portion 5.

### Rotor Shaft

The rotor shaft (rotor) 2 is rotatable about an axis O in the casing 3. The rotor shaft 2 includes a rotor shaft body 21 and a plurality of rotor blade rows 23.

Note that for convenience of the following description, a direction in which the axis O extends is an axial direction Da. A first side in the axial direction Da is an upstream side Dau (one side), and a second side in the axial direction Da is a downstream side Dad (other side). A radial direction Dr in the rotor shaft 2 with reference to the axis O is simply a radial direction Dr. A side approaching the axis O in this radial direction Dr is an inner side Dri of the radial direction Dr, and a side of this radial direction Dr opposite to the inner side Dri of the radial direction Dr is an outer side Dro of the radial direction Dr. A circumferential direction Dc of the rotor shaft 2 about the axis O is simply the circumferential direction Dc.

The rotor shaft body 21 extends in the axial direction Da about the axis O. The rotor shaft body 21 is supported rotatably around the axis O with respect to the casing 3 by the bearing portion 5.

The rotor blade row 23 is fixed to the outer side Dro of the rotor shaft body 21 in the radial direction Dr. The plurality of rotor blade rows 23 are arranged at intervals in the axial direction Da with respect to the rotor shaft body 21. In the case of the present embodiment, for example, a total of seven rotor blade rows 23 are arranged from the rotor blade row 23 positioned on the most upstream side Dau in the axial direction Da to the rotor blade row 23 positioned on the most downstream side Dad in the axial direction Da. Each of the rotor blade rows 23 includes a plurality of rotor blades 24 arranged side by side in the circumferential direction Dc.

### Casing

The casing 3 is formed in a tubular shape extending in the axial direction Da about the axis O. The casing 3 rotatably covers the rotor shaft 2. The casing 3 is formed so as to cover the rotor shaft body 21 and the plurality of rotor blades 24 from the outer side Dro in the radial direction Dr. A primary flow path 31 through which high-pressure steam S can flow is formed inside the casing 3. In the primary flow path 31, the plurality of rotor blade rows 23 and the stator vane rows 4 are arranged.

In the primary flow path 31, the high-pressure steam S flows while the pressure gradually decreases from the upstream side Dau toward the downstream side Dad in the axial direction Da. The primary flow path 31 is formed annularly around the rotor shaft body 21. The primary flow path 31 extends in the axial direction Da across the plurality of rotor blade rows 23 and the stator vane rows 4. A part of the primary flow path 31 is formed by an annular space in which a stator vane 41 described later is arranged.

The stator vane row 4 is fixed to the inner side Dri of the casing 3 in the radial direction Dr. The plurality of the stator vane rows 4 are arranged at intervals in the axial direction Da. For the stator vane row 4 of the present embodiment, for example, a total of seven, from the stator vane row 4 positioned on the most upstream side Dau in the axial direction Da to the stator vane row 4 positioned on the most downstream side Dad in the axial direction Da are arranged. Each of the stator vane rows 4 is arranged side by side on the upstream side Dau with respect to a respective one of the rotor blade rows 23.

Each of the stator vane rows 4 includes the plurality of stator vanes 41 arranged side by side in the circumferential direction Dc. The plurality of stator vanes 41 are arranged at intervals in the circumferential direction Dc. The stator vanes 41 are fixed to the inner side Dri of the casing 3 in the radial direction Dr. The stator vanes 41 are fixed to an inside surface of the casing 3. The inside surface of the casing 3 is a surface facing the inner side Dri of the radial direction Dr in the casing 3 and facing the primary flow path 31. The inside surface of the casing 3 is a surface opposing the tip end of the rotor blade 24 at a position shifted in the axial direction Da from the position where the stator vane 41 is fixed. The stator vane row 4 forms one stage by each pair of the stator vane row 4 and one of the rotor blade rows 23 arranged side by side on the downstream side Dad of this stator vane row 4. That is, a pair of the stator vane 41 and the rotor blade 24 arranged side by side in the axial direction Da forms one stage. Accordingly, with respect to the plurality of rotor blades 24 arranged side by side in the circumferential direction Dc, the plurality of stator vanes 41 arranged in the circumferential direction Dc are arranged on the upstream side Dau in the axial direction Da.

### Bearing Portion

The bearing portion 5 rotatably supports the rotor shaft body 21 about the axis O. The bearing portion 5 is arranged inside the casing 3. The bearing portion 5 includes a journal bearing 51 and the thrust bearing 6.

The journal bearing 51 supports the rotor shaft body 21 at a position close to an end portion of the rotor shaft body 21 with respect to a plurality of stages of the stator vanes 41 and the rotor blades 24 in the axial direction Da. The journal bearing 51 supports a load to the radial direction Dr acting on the rotor shaft body 21. A pair of the journal bearings 51 are arranged sandwiching the plurality of stages of the stator vanes 41 and the rotor blades 24 in the axial direction Da.

### Thrust Bearing

The thrust bearing 6 supports a load to the axial direction Da acting on the rotor shaft body 21. Thrust bearing 6 is arranged at a position close to an end portion of the rotor shaft body 21 with respect to journal bearing 51 on one side. The thrust bearing 6 of the present embodiment is arranged at a position close to the end portion of the rotor shaft body 21 with respect to the journal bearing 51 positioned on the upstream side Dau in the axial direction Da in the pair of journal bearings 51. The thrust bearing 6 is a tilting pad bearing.

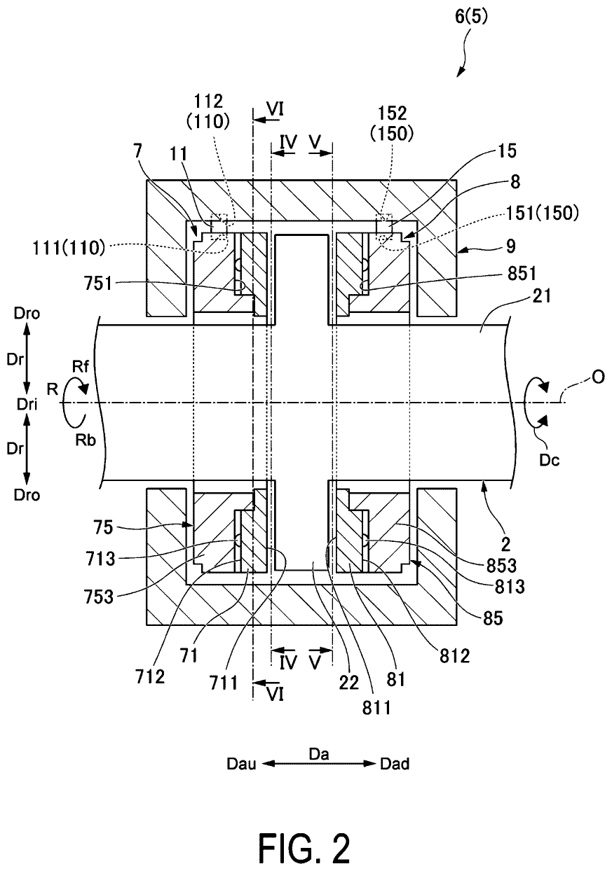

As illustrated in FIG. 2, the thrust bearing 6 supports the rotor shaft 2 via a thrust collar 22. The thrust collar 22 is formed on the rotor shaft 2. The thrust collar 22 protrudes to the outer side Dro in the radial direction Dr from the rotor shaft body 21 so as to form a circular shape. A region where the thrust collar 22 is formed is a region supported by the thrust bearing 6. In the case of the steam turbine 1 of the present embodiment as illustrated in FIG. 1, the load in the axial direction Da acting on the rotor shaft body 21 is generated in the thrust collar 22 from the upstream side Dau toward the downstream side Dad in the axial direction Da. Thus, the thrust bearing 6 needs to support a large load at the position on the downstream side Dad in the axial direction Da as compared with the position on the upstream side Dau in the axial direction Da with respect to the thrust collar 22.

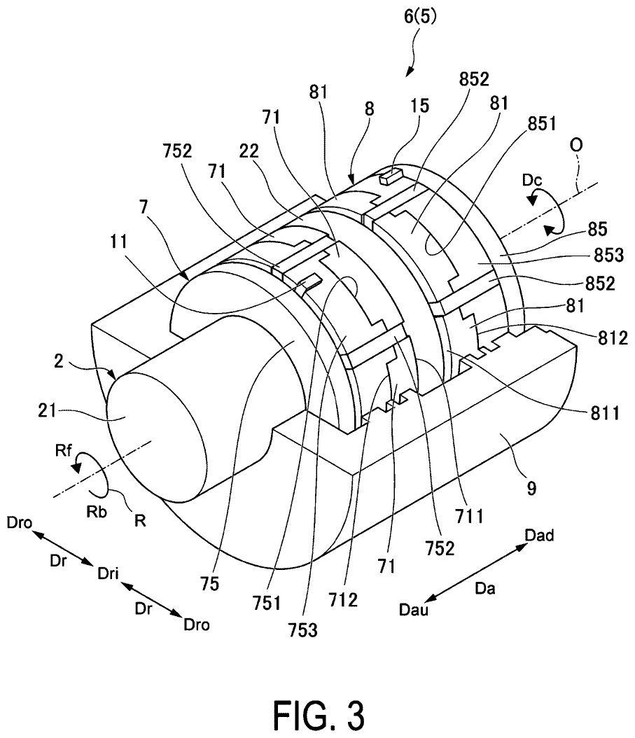

As illustrated in FIGS. 2 and 3, the thrust bearing 6 of the present embodiment includes a first bearing assembly 7, a second bearing assembly 8, a bearing cover 9, a first key 11, and a second key 15.

The first bearing assembly 7 is arranged on the upstream side Dau in the axial direction Da with respect to the thrust collar 22. That is, the first bearing assembly 7 is arranged at a position where a load in the axial direction Da generated in the thrust collar 22 is small. The first bearing assembly 7 is formed annularly about the axis O. In the first bearing assembly 7, the rotor shaft body 21 can be inserted through the inner side Dri. The first bearing assembly 7 of the present embodiment includes a first pad assembly 71 and a first carrying case 75.

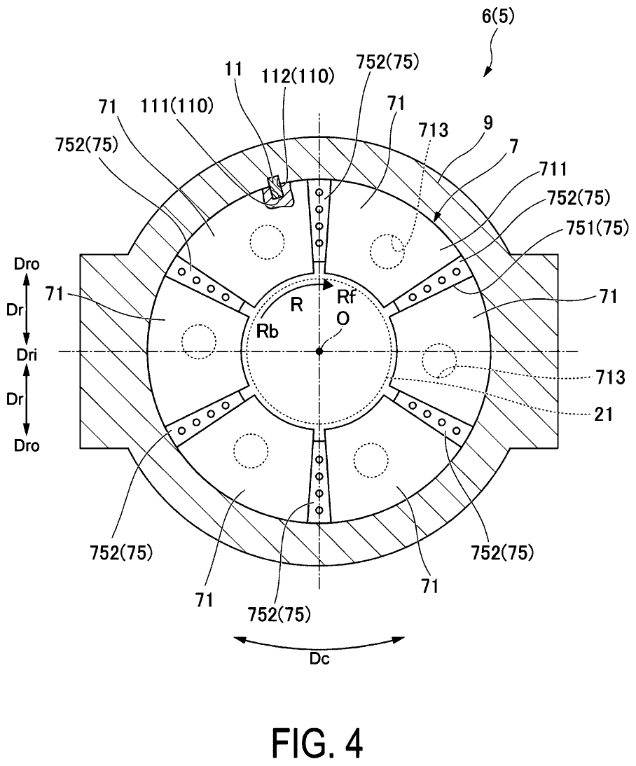

As illustrated in FIG. 4, a plurality of (six in the present embodiment) the first pad assemblies 71 are arranged apart from each other in the circumferential direction Dc. The plurality of first pad assemblies 71 all have an identical shape. The plurality of first pad assemblies 71 are arranged evenly apart in the circumferential direction Dc and thus arranged annularly. As illustrated in FIG. 2, the first pad assembly 71 includes a first pad surface 711, a first pad rear surface 712, and a first pivot 713.

The first pad surface 711 opposes the thrust collar 22 in the axial direction Da. The first pad surface 711 supports, from the axial direction Da via the lubricating oil, a surface facing the upstream side Dau in the axial direction Da of the thrust collar 22. As illustrated in FIG. 4, the first pad surface 711 is a flat surface having a fan shape facing the downstream side Dad in the axial direction Da. The first pad surface 711 is formed in a symmetrical shape in the circumferential direction Dc when viewed from the axial direction Da.

As illustrated in FIG. 2, the first pad rear surface 712 faces the opposite side in the axial direction Da with respect to the first pad surface 711. The first pad rear surface 712 is a flat surface having a fan shape facing the upstream side Dau in the axial direction Da so as to be formed with a smaller outside diameter than that of the first pad surface 711.

The first pivot 713 is formed such that the first pad surface 711 can be inclined with respect to the thrust collar 22. The first pivot 713 protrudes in the axial direction Da from the first pad rear surface 712. The first pivot 713 protrudes to the upstream side Dau in the axial direction Da from the first pad rear surface 712. The first pivot 713 is in contact with the first carrying case 75 in a rockable state.

Here, as illustrated in FIG. 4, in the circumferential direction Dc, the direction in which the rotor shaft 2 rotates is a rotational direction R. In the rotational direction R, one side in the circumferential direction Dc that is a destination of rotation from now is a front side Rf in the rotational direction R. In the rotational direction R, the opposite side in the circumferential direction Dc with respect to the front side Rf, that is, the other side in the circumferential direction Dc, is a rear side Rb in the rotational direction R.

The first pivot 713 is arranged at a position shifted to the front side Rf in the rotational direction R with respect to the center position in the circumferential direction Dc of the first pad rear surface 712 (first pad surface 711) when the first pad assembly 71 is viewed from axial direction Da so as to face first pad surface 711.

The first carrying case 75 can specify the positions of the plurality of first pad assemblies 71. The first carrying case 75 is formed annularly about the axis O. The first carrying case 75 has a vertically dividable structure.

Accordingly, the first carrying case 75 is brought into a state where the rotor shaft body 21 is inserted into the inner side Dri by arranging the upper half member above the rotor shaft body 21 in a state where the lower half member is arranged below the rotor shaft body 21. That is, the first carrying case 75 can be attached to the rotor shaft body 21 before the first pad assembly 71 is attached. As illustrated in FIG. 2, a plurality of first insertion grooves 751 are formed in the first carrying case 75.

The first pad assembly 71 can be inserted into the first insertion groove 751 from the outer side Dro in the radial direction Dr. The first insertion groove 751 is recessed from the outside surface of the first carrying case 75 toward the inner side Dri in the radial direction Dr. The first insertion groove 751 can hold, at the first specified position, the first pad assembly 71 inserted from the outer side Dro in the radial direction Dr. Here, the first specified position is an appropriate position where the first pad assembly 71 can stably receive a load when used in the thrust bearing 6 with respect to the first carrying case 75. In the present embodiment, at the first specified position, the first pad assembly 71 is brought into a state of not protruding to the outer side Dro in the radial direction Dr from the outside surface of the first carrying case 75. Only one first pad assembly 71 can be inserted into the first insertion groove 751. Thus, the plurality of first insertion grooves 751 are formed in one first carrying case 75. The plurality of first insertion grooves 751 are arranged evenly apart in the circumferential direction Dc. The plurality of first insertion grooves 751 are all formed in the same shape. The first insertion groove 751 is formed in an asymmetric shape in the circumferential direction Dc when viewed from the axial direction Da. The first insertion groove 751 is formed in a shape by which a second pad assembly 81 described later cannot be inserted up to the first specified position.

As illustrated in FIG. 3, the first carrying case 75 of the present embodiment includes a first lubrication nozzle 752 and a first case body 753. The first lubrication nozzle 752 can inject lubricating oil toward the thrust collar 22. As illustrated in FIG. 4, the first lubrication nozzle 752 has, at the center in the circumferential direction Dc, a plurality of openings through which lubricating oil is injected. The first lubrication nozzle 752 injects lubricating oil toward the downstream side Dad in the axial direction Da. The first lubrication nozzle 752 is arranged between the first pad assemblies 71 adjacent to each other. The first lubrication nozzle 752 is arranged at a position not overlapping the first insertion groove 751 when viewed from the axial direction Da. The first lubrication nozzle 752 is formed such that the width in the circumferential direction Dc decreases from the upstream side Dau toward the downstream side Dad in the axial direction Da (approaching the first pad surface 711 from the first pad rear surface 712 in the axial direction Da).

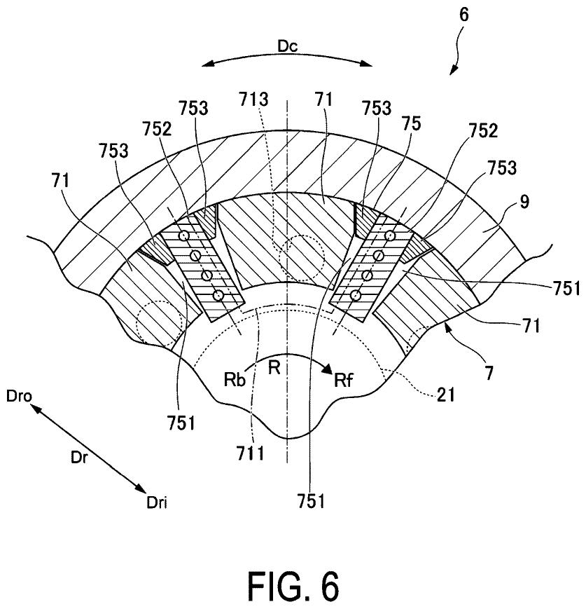

As illustrated in FIG. 6, a plurality of the first lubrication nozzles 752 are fixed to the first case body 753. The first insertion groove 751 is formed in the first case body 753. In the first case body 753, the first insertion groove 751 is formed between two first lubrication nozzles 752 adjacent to each other in the circumferential direction Dc.

In the first insertion groove 751 of the present embodiment, a region on the outer side Dro in the radial direction Dr is formed by the first case body 753. Accordingly, the first insertion groove 751 has the width in the circumferential direction Dc of the region of the outer side Dro in the radial direction Dr specified by the first case body 753. In the first insertion groove 751, the region of the inner side Dri in the radial direction Dr is formed by two first lubrication nozzles 752 adjacent to each other in the circumferential direction Dc. Accordingly, the first insertion groove 751 has the width in the circumferential direction Dc of the region of the inner side Dri in the radial direction Dr specified by two first lubrication nozzles 752 adjacent to each other in the circumferential direction Dc. Furthermore, in a state where the first pad assembly 71 is inserted into the first insertion groove 751, the first case body 753 and the first lubrication nozzle 752 do not interfere (contact) with the first pad assembly 71. On the other hand, in a state where the second pad assembly 81 is inserted into the first insertion groove 751, only the first case body 753 interferes (contacts) with the second pad assembly 81, and the second pad assembly 81 cannot be inserted up to the first specified position.

As illustrated in FIGS. 2 and 3, the second bearing assembly 8 is arranged opposite to the first bearing assembly 7 in the axial direction Da with reference to the thrust collar 22. That is, the second bearing assembly 8 is arranged on the downstream side Dad in the axial direction Da with respect to the thrust collar 22. Accordingly, the second bearing assembly 8 is arranged at a position where the load in the axial direction Da generated in the thrust collar 22 is large. Thus, the second bearing assembly 8 can support a larger load compared with the first bearing assembly 7. The second bearing assembly 8 is formed annularly about the axis O. In the second bearing assembly 8, the rotor shaft body 21 can be inserted through the inner side Dri. The first bearing assembly 7 and the second bearing assembly 8 have an identical size in the axial direction Da. The second bearing assembly 8 of the present embodiment includes a second pad assembly 81 and a second carrying case 85.

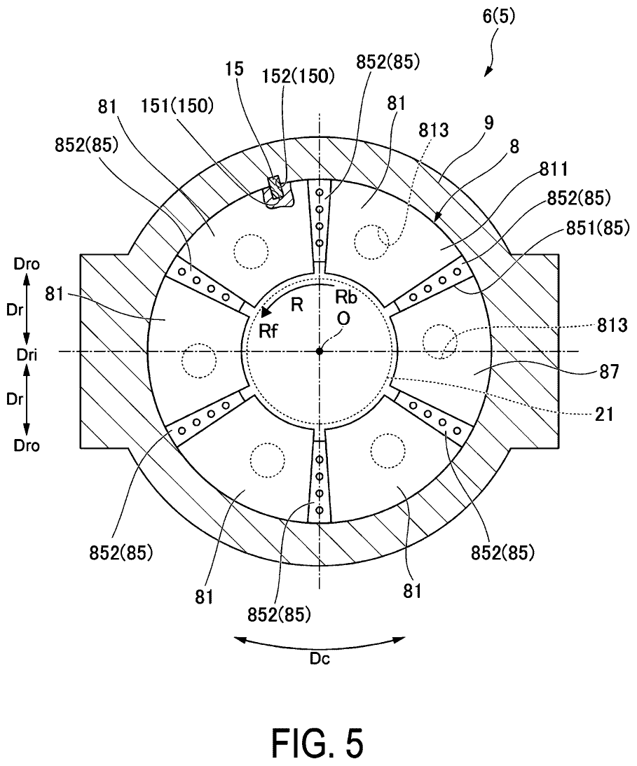

As illustrated in FIG. 5, a plurality of (six in the present embodiment) the second pad assemblies 81 are arranged apart from each other in the circumferential direction Dc. As many the second pad assemblies 81 as the first pad assemblies 71 are arranged. The plurality of second pad assemblies 81 all have an identical shape. The second pad assembly 81 of the present embodiment is formed in a shape different from that of the first pad assembly 71. The second pad assembly 81 has a shape similar to that of the first pad assembly 71, but does not have a completely matched shape, and has an outside diameter different from that of the first pad assembly 71. The second pad assembly 81 is different from the first pad assembly 71 in that the position of a second pivot 813 described later is shifted in the circumferential direction Dc with respect to the position of the first pivot 713. The plurality of second pad assemblies 81 are arranged evenly apart in the circumferential direction Dc and thus arranged annularly. As illustrated in FIG. 2, the second pad assembly 81 includes a second pad surface 811, a second pad rear surface 812, and a second pivot 813.

The second pad surface 811 opposes the thrust collar 22 in the axial direction Da. The second pad surface 811 is a flat surface having a fan shape facing the upstream side Dau in the axial direction Da. The second pad surface 811 supports, from the axial direction Da via the lubricating oil, a surface facing the downstream side Dad in the axial direction Da of the thrust collar 22. The second pad surface 811 is arranged in an orientation facing the first pad surface 711 in the axial direction Da. As illustrated in FIG. 5, the second pad surface 811 is formed in a symmetrical shape in the circumferential direction Dc when viewed from the axial direction Da. The second pad surface 811 has a reflection symmetric (planar symmetry with respect to a virtual plane passing through the axis O) shape as if being reflected in the mirror across the first pad surface 711 and the thrust bearing 6.

As illustrated in FIG. 2, the second pad rear surface 812 faces the opposite side in the axial direction Da with respect to the second pad surface 811. The second pad rear surface 812 is a flat surface having a fan shape facing the downstream side Dad in the axial direction Da so as to be formed with a smaller outside diameter than that of the second pad surface 811. The second pad rear surface 812 has an outside diameter different from that of the first pad rear surface 712.

The second pivot 813 is formed such that the second pad surface 811 can be inclined with respect to the thrust collar 22. The second pivot 813 protrudes in the axial direction Da from the second pad rear surface 812. The second pivot 813 protrudes to the downstream side Dad in the axial direction Da from the second pad rear surface 812. The second pivot 813 is in contact with the second carrying case 85 in a rockable state.

As illustrated in FIG. 5, the second pivot 813 is arranged at a position shifted to the front side Rf in the rotational direction R with respect to the center position in the circumferential direction Dc of the second pad rear surface 812 (second pad surface 811 when the second pad assembly 81 is viewed in the axial direction Da so as to face the second pad surface 811). Accordingly, when the first pad assembly 71 and the second pad assembly 81 are viewed from the axial direction Da in a state where the first pad surface 711 and the second pad surface 811 face each other in the axial direction Da and in a state where positions in the circumferential direction Dc and the radial direction Dr overlap each other, the first pivot 713 and the second pivot 813 are arranged overlapping each other in the circumferential direction Dc. Accordingly, the first pivot 713 and the second pivot 813 are arranged at reflection symmetric positions. That is, the position of the first pivot 713 on the first pad rear surface 712 of the first pad assembly 71 and the position of the second pivot 813 on the second pad rear surface 812 of the second pad assembly 81 are shifted in the circumferential direction Dc.

The second carrying case 85 can specify the positions of the plurality of second pad assemblies 81. The second carrying case 85 is formed annularly about the axis O. The second carrying case 85 has a vertically dividable structure. Accordingly, the second carrying case 85 is brought into a state where the rotor shaft body 21 is inserted into the inner side Dri by arranging the upper half member above the rotor shaft body 21 in a state where the lower half member is arranged below the rotor shaft body 21. That is, the second carrying case 85 can be attached to the rotor shaft body 21 before the second pad assembly 81 is attached. As illustrated in FIG. 2, a plurality of second insertion grooves 851 are formed in the second carrying case 85.

The second pad assembly 81 can be inserted into the second insertion groove 851 from the outer side Dro in the radial direction Dr. The second insertion groove 851 is recessed from the outside surface of the second carrying case 85 toward the inner side Dri in the radial direction Dr. The second insertion groove 851 can hold, at the second specified position, the second pad assembly 81 inserted from the outer side Dro in the radial direction Dr. Here, the second specified position is an appropriate position where the second pad assembly 81 can stably receive a load when used in the thrust bearing 6 with respect to the second carrying case 85. Only one second pad assembly 81 can be inserted into the second insertion groove 851. Thus, the plurality of second insertion grooves 851 are formed in one second carrying case 85. The plurality of second insertion grooves 851 are arranged evenly apart in the circumferential direction Dc. The plurality of second insertion grooves 851 are all formed in the same shape. The second insertion groove 851 is formed in an asymmetric shape in the circumferential direction Dc when viewed from the axial direction Da. The second insertion groove 851 has a shape different from that of the first insertion groove 751. The second insertion groove 851 is formed in a shape by which the first pad assembly 71 cannot be inserted up to the second specified position.

As illustrated in FIG. 3, the second carrying case 85 of the present embodiment includes a second lubrication nozzle 852 and a second case body 853. The second lubrication nozzle 852 can inject lubricating oil toward the thrust collar 22. As illustrated in FIG. 5, the second lubrication nozzle 852 has, at the center in the circumferential direction Dc, a plurality of openings through which lubricating oil is injected. The second lubrication nozzle 852 is arranged between the second pad assemblies 81 adjacent to each other. The second lubrication nozzle 852 is arranged at a position not overlapping the second insertion groove 851 when viewed from the axial direction Da. The second lubrication nozzle 852 is formed such that the width in the circumferential direction Dc decreases from the downstream side Dad toward the upstream side Dau in the axial direction Da (approaching the second pad surface 811 from the second pad rear surface 812 in the axial direction Da). The second lubrication nozzle 852 is formed in the same shape as that of the first lubrication nozzle 752.

As illustrated in FIG. 3, a plurality of the second lubrication nozzles 852 are fixed to the second case body 853. The second insertion groove 851 is formed in the second case body 853. In the second case body 853, the second insertion groove 851 is arranged between two second lubrication nozzles 852 adjacent to each other in the circumferential direction Dc.

In the second insertion groove 851 of the present embodiment, a region on the outer side Dro in the radial direction Dr is formed by the second case body 853. Accordingly, the second insertion groove 851 has the width in the circumferential direction Dc of the region of the outer side Dro in the radial direction Dr specified by the second case body 853. In the second insertion groove 851, the region of the inner side Dri in the radial direction Dr is formed by two second lubrication nozzles 852 adjacent to each other in the circumferential direction Dc. Accordingly, the second insertion groove 851 has the width in the circumferential direction Dc of the region of the inner side Dri in the radial direction Dr specified by two second lubrication nozzles 852 adjacent to each other in the circumferential direction Dc. Furthermore, in the state where the second pad assembly 81 is inserted into the second insertion groove 851, the second case body 853 and the second lubrication nozzle 852 do not interfere (contact) with the second pad assembly 81. On the other hand, in a state where the first pad assembly 71 described later is inserted into the second insertion groove 851, only the second case body 853 interferes (contacts) with the first pad assembly 71, and the first pad assembly 71 cannot be inserted up to the second specified position.

As described above, the shapes of the first pad assembly 71 and the second pad assembly 81 and the shapes of the first insertion groove 751 and the second insertion groove 851 are different from each other. Specifically, as illustrated in FIGS. 4 and 6, the first insertion groove 751 is brought into a state where the first pad assembly 71 does not protrude to the outer side Dro in the radial direction Dr from the outside surface of the first carrying case 75 in the state where the first pad assembly 71 is inserted. That is, in the state where the first pad assembly 71 is inserted into the first insertion groove 751, the first pad assembly 71 is inserted up to the first specified position with respect to the first carrying case 75. Thus, the first insertion groove 751 is formed in a shape by which the first pad assembly 71 can be inserted up to the first specified position without interfering with the first carrying case 75.

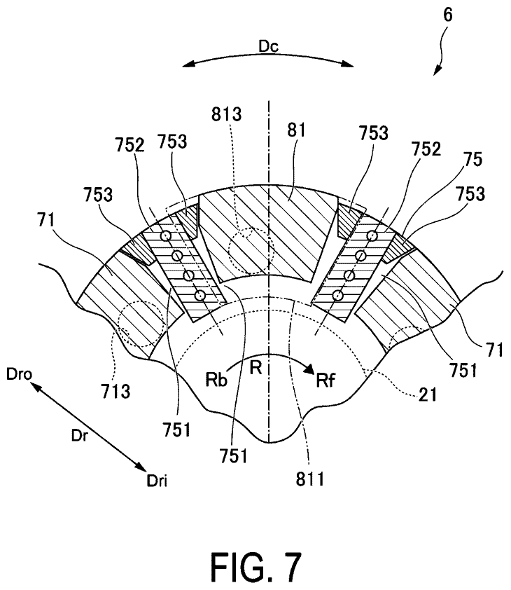

On the other hand, as illustrated in FIG. 7, the first insertion groove 751 is formed into a shape in a state where the second pad assembly 81 protrudes to the outer side Dro in the radial direction Dr from the outside surface of the first carrying case 75 in the state where the second pad assembly 81 is inserted. That is, in the state where the second pad assembly 81 is inserted into the first insertion groove 751, the second pad assembly 81 cannot be inserted up to the first specified position with respect to the first carrying case 75. The first insertion groove 751 is formed in a shape by which the second pad assembly 81 cannot be inserted up to the first specified position while interfering with the first carrying case 75. More specifically, the first insertion groove 751 is formed such that the second pad assembly 81 and the first case body 753 come into contact with each other in the state where the second pad assembly 81 is inserted.

As illustrated in FIG. 5, the second insertion groove 851 is formed in such a shape in a state where the second pad assembly 81 does not protrude to the outer side Dro in the radial direction Dr from the outside surface of the second carrying case 85 in the state where the second pad assembly 81 is inserted. That is, in the state where the second pad assembly 81 is inserted into the second insertion groove 851, the second pad assembly 81 is inserted up to the second specified position with respect to the second carrying case 85. Thus, the second insertion groove 851 is formed in a shape by which the second pad assembly 81 can be inserted up to the second specified position without interfering with the second carrying case 85.

On the other hand, the second insertion groove 851 is formed into a shape in a state where the first pad assembly 71 protrudes to the outer side Dro in the radial direction Dr from the outside surface of the second carrying case 85 in the state where the first pad assembly 71 is inserted. That is, in the state where the first pad assembly 71 is inserted into the second insertion groove 851, the first pad assembly 71 cannot be inserted up to the second specified position with respect to the second carrying case 85. The second insertion groove 851 is formed in a shape by which the first pad assembly 71 cannot be inserted up to the second specified position while interfering with the second carrying case 85. More specifically, the second insertion groove 851 is formed such that the first pad assembly 71 and the second case body 853 come into contact with each other in the state where the first pad assembly 71 is inserted.

As illustrated in FIG. 2, the bearing cover 9 can accommodate the first bearing assembly 7 and the second bearing assembly 8. The bearing cover 9 covers the first bearing assembly 7 and the second bearing assembly 8 together with the thrust collar 22. The bearing cover 9 is formed in a tubular shape extending in the axial direction Da about the axis O. The rotor shaft body 21 is inserted through a center portion of the bearing cover 9. The bearing cover 9 of the present embodiment is formed as a separate member from the casing 3. Note that the bearing cover 9 is not limited to being a separate member from the casing 3, and may be formed integrally with the casing 3. The bearing cover 9 has a vertically dividable structure. Thus, the thrust collar 22, the first bearing assembly 7, and the second bearing assembly 8 are arranged inside in a state where the lower half member is arranged below the rotor shaft body 21, and the upper half member is closed from above the rotor shaft body 21, whereby the bearing cover 9 is brought into a state where the rotor shaft body 21 is inserted into the inner side Dri.

As illustrated in FIGS. 2 and 4, the first key 11 specifies the position in the circumferential direction Dc of the first bearing assembly 7 with respect to the bearing cover 9. Only one first key 11 is arranged with respect to the bearing cover 9 and the first bearing assembly 7. The first key 11 is arranged in the upper half of the bearing cover 9 and the first bearing assembly 7. The first key 11 is accommodated in a first key seat 110 formed in the first carrying case 75 and the bearing cover 9.

Specifically, the first key seat 110 includes an inner first key seat 111 formed in the first carrying case 75 and an outer first key seat 112 formed in the bearing cover 9. The inner first key seat 111 is formed to be recessed to the inner side Dri in the radial direction Dr from the outside surface (surface facing the outer side Dro in the radial direction Dr) of the first carrying case 75. The inner first key seat 111 is formed to be recessed to the inner side Dri in the radial direction Dr from the outside surface of the first case body 753. In the inner first key seat 111, a part of the first key 11 can be inserted in an immovable state in the axial direction Da and the circumferential direction Dc. The inner first key seat 111 is formed to have a depth that causes a part of the inserted first key 11 to protrude toward the outer side Dro in the radial direction Dr.

The outer first key seat 112 is formed to be recessed to the outer side Dro in the radial direction Dr from the inside surface (surface facing the inner side Dri in the radial direction Dr) of the bearing cover 9. The outer first key seat 112 is formed to be recessed to the inner side Dri in the radial direction Dr from the inside surface of the bearing cover 9 of the upper half. In the outer first key seat 112, a part of the first key 11 can be inserted in an immovable state in the axial direction Da and the circumferential direction Dc. The outer first key seat 112 is formed to have a depth that can accommodate the first key 11 in a state of being inserted into the inner first key seat 111 and partially protruding.

As illustrated in FIGS. 2 and 5, the second key 15 specifies the position in the circumferential direction Dc of the second bearing assembly 8 with respect to the bearing cover 9. Only one second key 15 is arranged with respect to the bearing cover 9 and the second bearing assembly 8. The second key 15 is another member arranged apart from the first key 11. The second key 15 is arranged in the upper half of the bearing cover 9 and the second bearing assembly 8. The second key 15 is accommodated in a second key seat 150 formed in the second carrying case 85 and the bearing cover 9. The second key 15 of the present embodiment is formed in the same shape as that of the first key 11. Accordingly, the second key seat 150 is also formed in the same shape as that of the first key seat 110.

Specifically, the second key seat 150 includes an inner second key seat 151 formed in the second carrying case 85 and an outer second key seat 152 formed in the bearing cover 9. The inner second key seat 151 is formed to be recessed to the inner side Dri in the radial direction Dr from the outside surface (surface facing the outer side Dro in the radial direction Dr) of the second carrying case 85. The inner second key seat 151 is formed to be recessed to the inner side Dri in the radial direction Dr from the outside surface of the second case body 853. In the inner second key seat 151, a part of the second key 15 can be inserted in an immovable state in the axial direction Da and the circumferential direction Dc. The inner second key seat 151 is formed to have a depth that causes a part of the inserted second key 15 to protrude toward the outer side Dro in the radial direction Dr.

The outer second key seat 152 is formed to be recessed to the outer side Dro in the radial direction Dr from the inside surface (surface facing the inner side Dri in the radial direction Dr) of the bearing cover 9. The outer second key seat 152 is formed to be recessed to the inner side Dri in the radial direction Dr from the inside surface of the bearing cover 9 of the upper half. The outer second key seat 152 is formed apart from the outer first key seat 112. In the outer second key seat 152, a part of the second key 15 can be inserted in an immovable state in the axial direction Da and the circumferential direction Dc. The outer second key seat 152 is formed to have a depth that can accommodate the second key 15 in a state of being inserted into the inner second key seat 151 and partially protruding.

### Actions and Effects

In the thrust bearing 6 configured as described above, the first pad assembly 71 is inserted from the outer side Dro in the radial direction Dr with respect to a first insertion hole, whereby the first bearing assembly 7 is configured by assembling the first pad assembly 71 to the first carrying case 75. Similarly, the second pad assembly 81 is inserted from the outer side Dro in the radial direction Dr with respect to a second insertion hole, whereby the second bearing assembly 8 is configured by assembling the second pad assembly 81 to the second carrying case 85. Therefore, the attachability in attaching the first pad assembly 71 and the second pad assembly 81 can be ensured. Furthermore, the first insertion groove 751 can hold the first pad assembly 71 at the first specified position, meanwhile the second pad assembly 81 cannot be inserted up to the first specified position. The second insertion groove 851 can hold the second pad assembly 81 at the second specified position, meanwhile the first pad assembly 71 cannot be inserted up to the second specified position. Accordingly, it is impossible to attach the second pad assembly 81 to the first carrying case 75 while having the attachability of the first pad assembly 71 to the first carrying case 75. Similarly, it is impossible to attach the first pad assembly 71 to the second carrying case 85 while having the attachability of the second pad assembly 81 to the second carrying case 85. As a result, erroneous attachment of the second pad assembly 81 to the first carrying case 75 and erroneous attachment of the first pad assembly 71 to the second carrying case 85 can be reduced. In this manner, a component having a different combination can be prevented from being attached in the thrust bearing 6 to reduce erroneous assembly.

The first insertion groove 751 is formed in a state of not protruding to the outer side Dro in the radial direction Dr from the outside surface of the first carrying case 75 when the first pad assembly 71 is inserted. On the other hand, the first insertion groove 751 is formed in a state where the second pad assembly 81 protrudes to the outer side Dro in the radial direction Dr from the outside surface of the first carrying case 75 in the state where the second pad assembly 81 is inserted. Similarly, the second insertion groove 851 is formed in a state of not protruding to the outer side Dro in the radial direction Dr from the outside surface of the second carrying case 85 when the second pad assembly 81 is inserted. On the other hand, the second insertion groove 851 is formed in a state where the first pad assembly 71 protrudes to the outer side Dro in the radial direction Dr from the outside surface of the second carrying case 85 in the state where the first pad assembly 71 is inserted. That is, only when an erroneous first pad assembly 71 or second pad assembly 81 is attached, the member protrudes from the outside surface of the first carrying case 75 or the second carrying case 85. Thus, in a case of erroneous attachment of the second pad assembly 81 to the first carrying case 75 or in a case of erroneous attachment of the first pad assembly 71 to the second carrying case 85, the assembly cannot be completed. This can immediately grasp an error in assembly.

The first insertion groove 751 is formed between two first lubrication nozzles 752, and the second pad assembly 81 and the first case body 753 come into contact with each other in the state where the second pad assembly 81 is inserted. Similarly, the second insertion groove 851 is formed between two second lubrication nozzles 852, and the first pad assembly 71 and the second case body 853 come into contact with each other in the state where the first pad assembly 71 is inserted. Thus, erroneous attachment of the second pad assembly 81 to the first carrying case 75 and erroneous attachment of the first pad assembly 71 to the second carrying case 85 can be reduced only by changing the shapes of the first case body 753 and the second case body 853. Furthermore, the shapes of the first insertion groove 751 and the second insertion groove 851 can be changed without being affected by the shapes of the first lubrication nozzle 752 and the second lubrication nozzle 852. Therefore, as in the present embodiment, the first lubrication nozzle 752 and the second lubrication nozzle 852 can have the identical shape.

In the rotary machine such as the steam turbine 1 including such a thrust bearing 6, components can be prevented from being erroneously assembled in the first bearing assembly 7 and the second bearing assembly 8. Therefore, a work error in assembling the steam turbine 1 can be reduced to improve workability.

### Second Embodiment

Next, a thrust bearing 6A according to the second embodiment of the disclosure will be described. Note that in the following description of the second embodiment, common components with the first embodiment described above are given the same reference signs in the drawings and explanations thereof are omitted. The thrust bearing 6A of the second embodiment has the shapes of a first insertion groove 751A and the second insertion groove 851 different from those of the first embodiment.

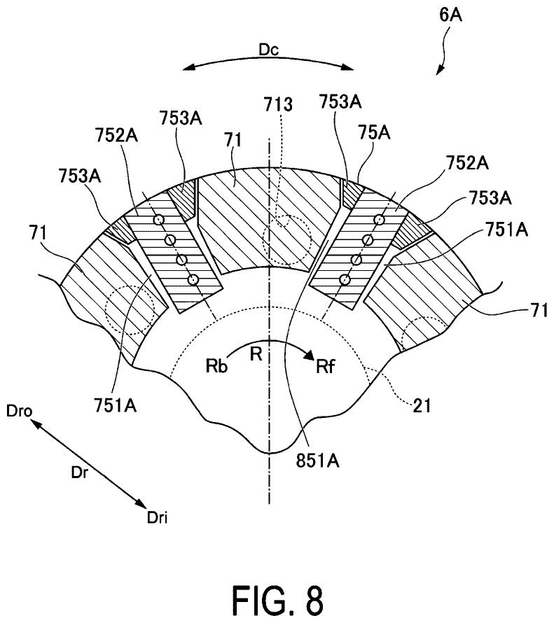

As illustrated in FIG. 8, in a first carrying case 75A of the second embodiment, a first lubrication nozzle 752A has, at positions shifted from the center in the circumferential direction Dc, a plurality of openings through which lubricating oil is injected. The first lubrication nozzle 752A is formed to have a larger width in the circumferential direction Dc than the first lubrication nozzle 752 of the first embodiment. This causes the first insertion groove 751A to be different in shape from the first insertion groove 751 of the first embodiment.

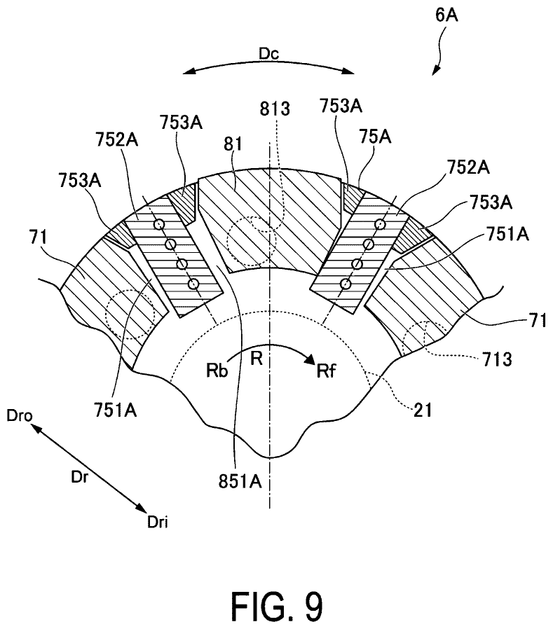

In a state where the first pad assembly 71 is inserted into the first insertion groove 751A, similarly to the first embodiment, a first case body 753A and the first lubrication nozzle 752A do not interfere (contact) with the first pad assembly 71. On the other hand, as illustrated in FIG. 9, in a state where the second pad assembly 81 is inserted into the first insertion groove 751A, unlike the first embodiment, the first case body 753A does not interfere (contact) with the second pad assembly 81. Instead, in the state where the second pad assembly 81 is inserted into the first insertion groove 751A, only the first lubrication nozzle 752A interferes (contacts) with the second pad assembly 81, and the second pad assembly 81 cannot be inserted up to the first specified position.

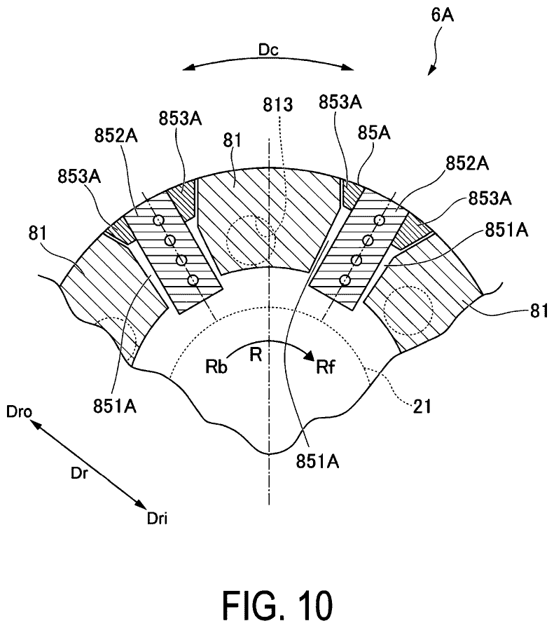

As illustrated in FIG. 10, a second carrying case 85A of the second embodiment is also similar to the first carrying case 75A. Specifically, in the second carrying case 85A, a second lubrication nozzle 852A has, at positions shifted from the center in the circumferential direction Dc, a plurality of openings through which lubricating oil is injected. The second lubrication nozzle 852A is formed to have a larger width in the circumferential direction Dc than the second lubrication nozzle 852 of the first embodiment. This causes a second insertion groove 851A to be different in shape from the second insertion groove 851 of the first embodiment.

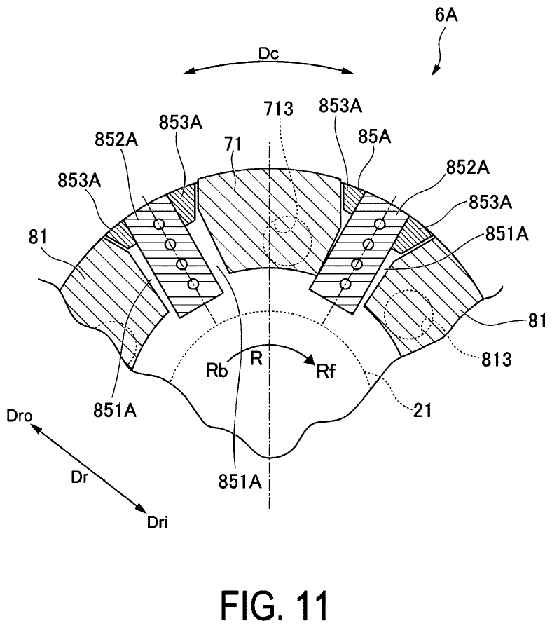

In the state where the second pad assembly 81 is inserted into the second insertion groove 851A, similarly to the first embodiment, the second case body 853A and the second lubrication nozzle 852A do not interfere (contact) with the second pad assembly 81. On the other hand, as illustrated in FIG. 11, in a state where the first pad assembly 71 is inserted into the second insertion groove 851A, unlike the first embodiment, the second case body 853A does not interfere (contact) with the second pad assembly 81. Instead, in the state where the first pad assembly 71 is inserted into the second insertion groove 851A, only the second lubrication nozzle 852A interferes (contacts) with the first pad assembly 71, and the first pad assembly 71 cannot be inserted up to the second specified position.

### Actions and Effects

In the thrust bearing 6 of the second embodiment, the first insertion groove 751A is formed between two first lubrication nozzles 752A, and the second pad assembly 81 and the first lubrication nozzle 752A come into contact with each other in the state where the second pad assembly 81 is inserted. Similarly, the second insertion groove 851 is formed between two second lubrication nozzles 852A, and the first pad assembly 71 and the second lubrication nozzle 852A come into contact with each other in the state where the first pad assembly 71 is inserted. Thus, erroneous attachment of the second pad assembly 81 to the first carrying case 75A and erroneous attachment of the first pad assembly 71 to the second carrying case 85A can be reduced only by changing the shapes of the first lubrication nozzle 752A and the second lubrication nozzle 852A. Since the first lubrication nozzle 752A and the second lubrication nozzle 852A whose shapes are easily grasped from the outer side have different shapes, the first carrying case 75A and the second carrying case 85A can be easily grasped.

### Third Embodiment

Next, a thrust bearing 6B according to the third embodiment of the disclosure will be described. Note that in the following description of the third embodiment, common components with the first embodiment described above are given the same reference signs in the drawings and explanations thereof are omitted. In the thrust bearing 6B of the second embodiment, the shapes of a first key 11B and the second key 15 are further different from those of the first embodiment.

In the third embodiment, the first key 11B and the second key 15 are formed in any one of the following shapes. First, the first key 11B is formed in a shape that cannot be accommodated in the second key seat 150, and the second key 15 is formed in a shape by which the second key 15 cannot be accommodated in the first key seat 110. Second, the first key 11B is formed in a shape that cannot be accommodated in the second key seat 150, and the second key 15 is formed in a shape by which the second key 15 can be accommodated in the first key seat 110. Third, the first key 11B is formed in a shape by which the first key 11B can be accommodated in the second key seat 150, and the second key 15 is formed in a shape by which the second key 15 cannot be accommodated in the first key seat 110.

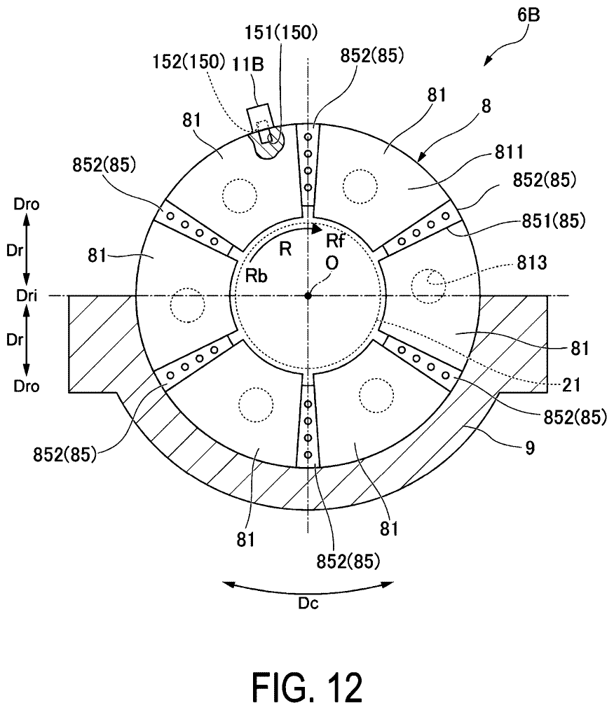

The shape that cannot be accommodated in the first key seat 110 and the second key seat 150 is, for example, a shape by which at least one of the first key 11B and the second key 15 cannot be completely accommodated in the first key seat 110 and the second key seat 150. As an example, as illustrated in FIG. 12, a shape in a state where the first key 11B cannot be inserted into the second key seat 150 will be described. The first key 11B is formed in a shape by which the first key 11B cannot be inserted into any of the inner second key seat 151 and the outer second key seat 152. Specifically, the first key 11B is formed to be thicker (larger) in the circumferential direction Dc than the second key 15. Since the first key 11B is longer in the circumferential direction Dc than the second key 15, the second key seat 150 is formed to be longer in the circumferential direction Dc than the second key seat 150 so that the first key seat 110 can be accommodated. Accordingly, the first key 11B cannot be inserted into the inner second key seat 151 nor the outer second key seat 152.

### Actions and Effects

In the thrust bearing 6 having the configuration of the third embodiment, at least one of the first key 11B and the second key 15 cannot be accommodated in one of the first key seat 110 and the second key seat 150. Therefore, the first bearing assembly 7 and the second bearing assembly 8 cannot be assembled to the bearing cover 9. Thus, when the attachment positions of the first bearing assembly 7 and the second bearing assembly 8 with respect to the thrust collar 22 are reversed, the assembly cannot be completed. This can immediately grasp an error in the attachment positions of the first bearing assembly 7 and the second bearing assembly 8.

As in the present embodiment, by making the first key 11B larger than the second key 15 and giving the first key 11B a shape by which the first key 11B cannot be inserted into the inner second key seat 151, the first key 11B cannot be inserted into the inner second key seat 151. Therefore, an error in the attachment positions of the first bearing assembly 7 and the second bearing assembly 8 can be immediately grasped before the bearing cover 9 is closed.

In particular, when the first key 11B is formed to be large in the circumferential direction Dc, an error in the attachment positions of the first bearing assembly 7 and the second bearing assembly 8 can be immediately grasped by easy machining only by changing the shape of the first key 11B, which is a small component among the components of the thrust bearing 6.

In the present embodiment, the first bearing assembly 7 and the second bearing assembly 8 have an identical size in the axial direction Da. Thus, even when the outer shapes of the first bearing assembly 7 and the second bearing assembly 8 are similar to each other, an error in the attachment positions of the first bearing assembly 7 and the second bearing assembly 8 can be immediately grasped only by changing the shape of the first key 11B.

### Modification Example of Third Embodiment

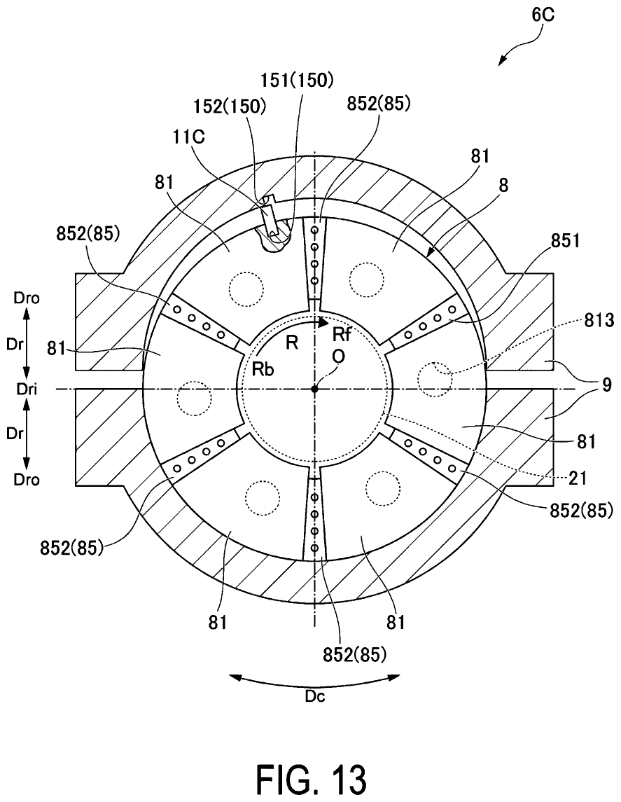

As a modification example of the third embodiment, for example, at least one of a first key 11C and the second key 15 may have, as a shape by which the first key 11C and the second key 15 cannot be inserted into the first key seat 110 and the second key seat 150, a shape by which the first key 11C and the second key 15 cannot be partially inserted into the first key seat 110 and the second key seat 150. As an example, as illustrated in FIG. 13, a shape in a state where the first key 11C cannot be partially inserted into the second key seat 150 will be described. The first key 11C is formed in a shape by which the first key 11C can be inserted into the inner second key seat 151 but cannot be inserted into the outer second key seat 152. Specifically, the first key 11C is formed longer (larger) in the radial direction Dr than the second key 15. Although the first key 11C is longer in the radial direction Dr than the first key seat 110 and the second key seat 150, the sizes in the axial direction Da and the circumferential direction Dc are identical. Furthermore, the sizes of the inner first key seat 111 and the inner second key seat 151 in the axial direction Da and the circumferential direction Dc are identical. Accordingly, the first key 11C can be inserted only into the inner second key seat 151 but cannot be inserted into the outer second key seat 152.

### Actions and Effects

Even in a thrust bearing 6C of the modification example of the third embodiment, the first key 11C cannot be accommodated in the second key seat 150. Therefore, the first bearing assembly 7 and the second bearing assembly 8 cannot be assembled to the bearing cover 9. Accordingly, when the attachment positions of the first bearing assembly 7 and the second bearing assembly 8 with respect to the thrust collar 22 are reversed, the assembly cannot be completed. This can immediately grasp an error in the attachment positions of the first bearing assembly 7 and the second bearing assembly 8.

### OTHER EMBODIMENTS

Although the embodiments of the disclosure have been described in detail with reference to the accompanying drawings, specific configurations are not limited to these embodiments, and design changes and the like without departing from the gist of the disclosure are also included.

Note that the rotary machine including the thrust bearing 6 is not limited to the steam turbine 1 as in the present embodiment. The rotary machine may be a compressor, a pump, or a motor as long as the rotary machine includes the rotor shaft 2 supported by the thrust bearing 6.

In the thrust bearing 6, the structure of the first bearing assembly 7 is not limited to the structure in which the first bearing assembly 7 is arranged on the upstream side Dau in the axial direction Da with respect to the thrust collar 22 and the second bearing assembly 8. In the thrust bearing 6, in accordance with the rotor shaft 2 supported by the thrust bearing 6, the second bearing assembly 8 is arranged at a position applied with a large load, and the first bearing assembly 7 is arranged at a position applied with a small load.

The number of first pad assemblies 71 and the number of second pad assemblies 81 are not limited to six as in the present embodiment. A plurality of first pad assemblies 71 and a plurality of second pad assemblies 81 is arranged, and the number of them may be five or less, or seven or more.

The second key 15 of the first embodiment may be formed in the same shape as the first key 11 or may be formed in a different shape. Thus, the second key seat 150 may also be formed in the same shape as the first key seat 110 or may be formed in a different shape.

Furthermore, in the third embodiment, the first keys 11B and 11C are not limited to be larger than the second key 15. The second key 15 may be formed to be larger than the first keys 11B and 11C.

### Supplementary Notes

The thrust bearing 6 and the steam turbine 1 described in the embodiments are understood as follows, for example.

(1) The thrust bearing 6 according to a first aspect is the thrust bearing 6 that supports, through a thrust collar 22 arranged protruding to an outer side Dro in a radial direction Dr from a rotor shaft 2 that rotates about an axis O, a load in an axial direction Da of the rotor shaft 2, the thrust bearing 6 including: a first bearing assembly 7 arranged on a first side in the axial direction Da with respect to the thrust collar 22; and a second bearing assembly 8 arranged opposite to the first bearing assembly 7 in the axial direction Da with reference to the thrust collar 22 and on a second side in the axial direction Da with respect to the thrust collar 22, in which the first bearing assembly 7 includes a plurality of first pad assemblies 71 having a first pad surface 711 opposing the thrust collar 22 in the axial direction Da, arranged apart in a circumferential direction Dc with respect to the thrust collar 22, and having an identical shape, and a first carrying case 75 or 75A in which a first insertion groove 751 or 751A that can hold, at a first specified position, a first pad assembly 71 of the plurality of first pad assemblies 71 inserted from the outer side Dro in the radial direction Dr is formed, the first carrying case 75 or 75A specifying positions of the plurality of first pad assemblies 71, the second bearing assembly 8 includes a plurality of second pad assemblies 81 having a second pad surface 811 opposing the thrust collar 22 in the axial direction Da, arranged apart in the circumferential direction Dc with respect to the thrust collar 22, and having an identical shape, and a second carrying case 85 or 85A in which a second insertion groove 851 that can hold, at a second specified position, a second pad assembly 81 of the plurality of second pad assemblies 81 inserted from the outer side Dro in the radial direction Dr is formed, the second carrying case 85 or 85A specifying positions of the plurality of second pad assemblies 81, the first insertion groove 751 or 751A is formed in a shape by which the second pad assembly 81 cannot be inserted up to the first specified position, and the second insertion groove 851 is formed in a shape by which the first pad assembly 71 cannot be inserted up to the second specified position.

This causes the first pad assembly 71 to be inserted from the outer side Dro in the radial direction Dr with respect to the first insertion hole, whereby the first bearing assembly 7 is configured by assembling the first pad assembly 71 to the first carrying case 75 or 75A. Similarly, the second pad assembly 81 is inserted from the outer side Dro in the radial direction Dr with respect to the second insertion hole, whereby the second bearing assembly 8 is configured by assembling the second pad assembly 81 to the second carrying case 85 or 85A. Therefore, the attachability in attaching the first pad assembly 71 and the second pad assembly 81 can be ensured. Furthermore, the first insertion groove 751 or 751A can hold the first pad assembly 71 at the first specified position, meanwhile the second pad assembly 81 cannot be inserted up to the first specified position. The second insertion groove 851 can hold the second pad assembly 81 at the second specified position, meanwhile the first pad assembly 71 cannot be inserted up to the second specified position. Accordingly, it is impossible to attach the second pad assembly 81 to the first carrying case 75 or 75A while having the attachability of the first pad assembly 71 to the first carrying case 75 or 75A. Similarly, it is impossible to attach the first pad assembly 71 to the second carrying case 85 or 85A while having the attachability of the second pad assembly 81 to the second carrying case 85 or 85A. As a result, erroneous attachment of the second pad assembly 81 to the first carrying case 75 or 75A and erroneous attachment of the first pad assembly 71 to the second carrying case 85 or 85A can be reduced. In this manner, a component having a different combination can be prevented from being attached in the thrust bearing 6 to reduce erroneous assembly.

(2) The thrust bearing 6 according to a second aspect is the thrust bearing 6 of (1), wherein the first insertion groove 751 or 751A is formed in a shape by which the first pad assembly 71 does not protrude to the outer side Dro in the radial direction Dr from an outside surface of the first carrying case 75 or 75A in a state where the first pad assembly 71 is inserted and the second pad assembly 81 protrudes to the outer side Dro in the radial direction Dr from the outside surface of the first carrying case 75 or 75A in a state where the second pad assembly 81 is inserted, and the second insertion groove 851 is formed in a shape by which the second pad assembly 81 does not protrude to the outer side Dro in the radial direction Dr from an outside surface of the second carrying case 85 or 85A in the state where the second pad assembly 81 is inserted and the first pad assembly 71 protrudes to the outer side Dro in the radial direction Dr from the outside surface of the second carrying case 85 or 85A in the state where the first pad assembly 71 is inserted.

Thus, only when an erroneous first pad assembly 71 or second pad assembly 81 is attached, the member protrudes from the outside surface of the first carrying case 75 or 75A or the second carrying case 85 or 85A. Thus, in a case of erroneous attachment of the second pad assembly 81 to the first carrying case 75 or 75A or in a case of erroneous attachment of the first pad assembly 71 to the second carrying case 85 or 85A, the assembly cannot be completed. This can immediately grasp an error in assembly.

(3) The thrust bearing 6 according to a third aspect is the thrust bearing 6 of (1) or (2), wherein the first carrying case 75 or 75A includes a plurality of first lubrication nozzles 752 or 752A arranged between the first pad assemblies 71 adjacent to each other and configured to inject lubricating oil toward the thrust collar 22 and a first case body 753 or 753A to which the plurality of first lubrication nozzles 752 or 752A are fixed, the second carrying case 85 or 85A includes a plurality of second lubrication nozzles 852 arranged between the second pad assemblies 81 adjacent to each other and configured to inject lubricating oil toward the thrust collar 22 and a second case body 853 to which the plurality of second lubrication nozzles 852 are fixed, the first insertion groove 751 or 751A is formed between two of the first lubrication nozzles 752 or 752A adjacent to each other in the circumferential direction Dc, the second pad assembly 81 and the first case body 753 or 753A come into contact with each other in a state where the second pad assembly 81 is inserted, the second insertion groove 851 is formed between two of the second lubrication nozzles 852 adjacent to each other in the circumferential direction Dc, and the first pad assembly 71 and the second case body 853 come into contact with each other in a state where the first pad assembly 71 is inserted.

This allows erroneous attachment of the second pad assembly 81 to the first carrying case 75 or 75A and erroneous attachment of the first pad assembly 71 to the second carrying case 85 or 85A to be reduced only by changing the shapes of the first case body 753 or 753A and the second case body 853. Furthermore, the shapes of the first insertion groove 751 or 751A and the second insertion groove 851 can be changed without being affected by the shapes of the first lubrication nozzle 752 or 752A and the second lubrication nozzle 852.

(4) The thrust bearing 6 according to a fourth aspect is the thrust bearing 6 of any one of (1) to (3), wherein the first carrying case 75 or 75A includes a plurality of first lubrication nozzles 752 or 752A arranged between the first pad assemblies 71 adjacent to each other and configured to inject lubricating oil toward the thrust collar 22 and a first case body 753 or 753A to which the plurality of first lubrication nozzles 752 or 752A are fixed, the second carrying case 85 or 85A includes a plurality of second lubrication nozzles 852 arranged between the second pad assemblies 81 adjacent to each other and configured to inject lubricating oil toward the thrust collar 22 and a second case body 853 to which the plurality of second lubrication nozzles 852 are fixed, the first insertion groove 751 or 751A is formed in the first case body 753 or 753A between two of the first lubrication nozzles 752 or 752A adjacent to each other in the circumferential direction Dc, the second pad assembly 81 and the first lubrication nozzle 752 or 752A come into contact with each other in a state where the second pad assembly 81 is inserted, the second insertion groove 851 is formed in the second case body 853 between two of the second lubrication nozzles 852 adjacent to each other in the circumferential direction Dc, and the first pad assembly 71 and the second lubrication nozzle 852 come into contact with each other in a state where the first pad assembly 71 is inserted.

This allows erroneous attachment of the second pad assembly 81 to the first carrying case 75 or 75A and erroneous attachment of the first pad assembly 71 to the second carrying case 85 or 85A to be reduced only by changing the shapes of the first lubrication nozzle 752 or 752A and the second lubrication nozzle 852. Since the first lubrication nozzle 752 or 752A and the second lubrication nozzle 852 whose shapes are easily grasped from the outer side have different shapes, the first carrying case 75 or 75A and the second carrying case 85 or 85A can be easily grasped.

(5) The thrust bearing 6 according to a fifth aspect is the thrust bearing 6 of any one of (1) to (4), including: a bearing cover 9 that can accommodate the first bearing assembly 7 and the second bearing assembly 8; a first key 11, 11B, or 11C specifying a position of the first bearing assembly 7 in the circumferential direction Dc with respect to the bearing cover 9; and a second key 15 specifying a position of the second bearing assembly 7 in the circumferential direction Dc with respect to the bearing cover 9, wherein the first key 11, 11B, or 11C is accommodated in a first key seat 110 formed in the first carrying case 75 or 75A and the bearing cover 9, the second key 15 is accommodated in a second key seat 150 formed in the second carrying case 85 or 85A and the bearing cover 9, and the first key 11, 11B, or 11C and the second key 15 are formed in any one of shapes: a shape by which the first key 11, 11B, or 11C cannot be accommodated in the second key seat 150 and a shape by which the second key 15 cannot be accommodated in the first key seat 110; a shape by which the first key 11, 11B, or 11C cannot be accommodated in the second key seat 150 and a shape by which the second key 15 can be accommodated in the first key seat 110; and a shape by which the first key 11, 11B, or 11C can be accommodated in the second key seat 150 and a shape by which the second key 15 cannot be accommodated in the first key seat 110.

Thus, the first bearing assembly 7 and the second bearing assembly 8 cannot be assembled to the bearing cover 9. Thus, when the attachment positions of the first bearing assembly 7 and the second bearing assembly 8 with respect to the thrust collar 22 are reversed, the assembly cannot be completed. This can immediately grasp an error in the attachment positions of the first bearing assembly 7 and the second bearing assembly 8.

(6) The thrust bearing 6 according to a sixth aspect is the thrust bearing 6 of any one of (1) to (5), wherein the first bearing assembly 7 and the second bearing assembly 8 have an identical size in the axial direction Da.

This allows, even when the outer shapes of the first bearing assembly 7 and the second bearing assembly 8 are similar to each other, an error in the attachment positions of the first bearing assembly 7 and the second bearing assembly 8 to be immediately grasped only by changing the shape of the first keys 11, 11B, or 11C.

(7) A rotary machine according to a seventh aspect includes the thrust bearing 6 of any one of (1) to (5), and the rotor shaft 2 rotatably supported by the thrust bearing 6.

This can reduce components from being erroneously assembled in the first bearing assembly 7 and the second bearing assembly 8. Therefore, a work error in assembling the steam turbine 1 can be reduced to improve workability.

While preferred embodiments of the invention have been described as above, it is to be understood that variations and modifications will be apparent to those skilled in the art without departing from the scope and spirit of the invention. The scope of the invention, therefore, is to be determined solely by the following claims.

1. A thrust bearing that supports, through a thrust collar arranged protruding to an outer side in a radial direction from a rotor shaft that rotates about an axis, a load in an axial direction of the rotor shaft, the thrust bearing comprising:
a first bearing assembly arranged on a first side in the axial direction with respect to the thrust collar; and
a second bearing assembly arranged opposite to the first bearing assembly in the axial direction with reference to the thrust collar and on a second side in the axial direction with respect to the thrust collar, wherein
the first bearing assembly includes
a plurality of first pad assemblies having a first pad surface opposing the thrust collar in the axial direction, arranged apart in a circumferential direction with respect to the thrust collar, and having an identical shape and
a first carrying case in which a first insertion groove that can hold, at a first specified position, a first pad assembly of the plurality of first pad assemblies inserted from the outer side in the radial direction is formed, the first carrying case specifying positions of the plurality of first pad assemblies,
the second bearing assembly includes
a plurality of second pad assemblies having a second pad surface opposing the thrust collar in the axial direction, arranged apart in the circumferential direction with respect to the thrust collar, and having an identical shape and
a second carrying case in which a second insertion groove that can hold, at a second specified position, a second pad assembly of the plurality of second pad assemblies inserted from the outer side in the radial direction is formed, the second carrying case specifying positions of the plurality of second pad assemblies,
the first insertion groove is formed in a shape by which the second pad assembly cannot be inserted up to the first specified position, and
the second insertion groove is formed in a shape by which the first pad assembly cannot be inserted up to the second specified position.

2. The thrust bearing according to claim 1, wherein
the first insertion groove is formed in a shape by which
the first pad assembly does not protrude to the outer side in the radial direction from an outside surface of the first carrying case in a state where the first pad assembly is inserted and
the second pad assembly protrudes to the outer side in the radial direction from the outside surface of the first carrying case in a state where the second pad assembly is inserted, and
the second insertion groove is formed in a shape by which
the second pad assembly does not protrude to the outer side in the radial direction from an outside surface of the second carrying case in the state where the second pad assembly is inserted and
the first pad assembly protrudes to the outer side in the radial direction from the outside surface of the second carrying case in the state where the first pad assembly is inserted.

3. The thrust bearing according to claim 1, wherein
the first carrying case includes a plurality of first lubrication nozzles arranged between the first pad assemblies adjacent to each other and configured to inject lubricating oil toward the thrust collar and a first case body to which the plurality of first lubrication nozzles are fixed,
the second carrying case includes a plurality of second lubrication nozzles arranged between the second pad assemblies adjacent to each other and configured to inject lubricating oil toward the thrust collar and a second case body to which the plurality of second lubrication nozzles are fixed,
the first insertion groove is formed between two of the first lubrication nozzles adjacent to each other in the circumferential direction, the second pad assembly and the first case body come into contact with each other in a state where the second pad assembly is inserted,
the second insertion groove is formed between two of the second lubrication nozzles adjacent to each other in the circumferential direction, and the first pad assembly and the second case body come into contact with each other in a state where the first pad assembly is inserted.

4. The thrust bearing according to claim 1, wherein
the first carrying case includes a plurality of first lubrication nozzles arranged between the first pad assemblies adjacent to each other and configured to inject lubricating oil toward the thrust collar and a first case body to which the plurality of first lubrication nozzles are fixed,
the second carrying case includes a plurality of second lubrication nozzles arranged between the second pad assemblies adjacent to each other and configured to inject lubricating oil toward the thrust collar and a second case body to which the plurality of second lubrication nozzles are fixed,
the first insertion groove is formed in the first case body between two of the first lubrication nozzles adjacent to each other in the circumferential direction, the second pad assembly and the first lubrication nozzle come into contact with each other in a state where the second pad assembly is inserted,
the second insertion groove is formed in the second case body between two of the second lubrication nozzles adjacent to each other in the circumferential direction, and the first pad assembly and the second lubrication nozzle come into contact with each other in a state where the first pad assembly is inserted.

5. The thrust bearing according to claim 1, comprising:
a bearing cover that can accommodate the first bearing assembly and the second bearing assembly;
a first key specifying a position of the first bearing assembly in the circumferential direction with respect to the bearing cover; and
a second key specifying a position of the second bearing assembly in the circumferential direction with respect to the bearing cover, wherein
the first key is accommodated in a first key seat formed in the first carrying case and the bearing cover,
the second key is accommodated in a second key seat formed in the second carrying case and the bearing cover, and
the first key and the second key are formed in any one of shapes: a shape by which the first key cannot be accommodated in the second key seat and a shape by which the second key cannot be accommodated in the first key seat; a shape by which the first key cannot be accommodated in the second key seat and a shape by which the second key can be accommodated in the first key seat; and a shape by which the first key can be accommodated in the second key seat and a shape by which the second key cannot be accommodated in the first key seat.

6. The thrust bearing according to claim 1, wherein the first bearing assembly and the second bearing assembly have an identical size in the axial direction.

7. A rotary machine, comprising:
the thrust bearing according to claim 1; and
the rotor shaft rotatably supported by the thrust bearing.
